(19) United States
(12) Patent Application Publication
(10) Pub. No.: US 2009/0193818 A1
(43) Pub. Date: Aug. 6, 2009

(54) Apparatus for Improved Precooling of a Thermal Radiation Shield in a Cryostat

(75) Inventors: Neil Charles TIGWELL, Oxon (GB); Stephen Paul Trowell, Oxon (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxon (GB)

(21) Appl. No.: 12/348,138

(22) Filed: Jan. 2, 2009

(30) Foreign Application Priority Data
Jan. 31, 2008 (GB) 0801687.5

(51) Int. Cl. F17C 3/02; F28F 27/00

(52) U.S. Cl. 62/51.1; 165/266; 165/276

(57) ABSTRACT

A cryostat comprises a cryogen vessel housed within an outer vacuum container (OVC), a thermal radiation shield being located between an external surface of the cryogen vessel and an internal surface of the OVC. A decouplable thermal link arrangement is provided between an external surface of the cryogen vessel and an internal surface of the thermal radiation shield, being decoupled by action of an applied magnetic field.

This application claims the priority of British patent document 0801687.5, filed Jan. 31, 2008, the disclosure(s) of which is (are) expressly incorporated by reference herein.

The present invention relates to cryostats for retaining cooled equipment such as superconductive magnet coils. In particular, the present invention relates to vacuum chambers and radiation thermal radiation shields provided for reducing heat reaching a cryogen vessel from cryostat components which are at a higher temperature, and especially to cooling arrangements for initially cooling the thermal radiation shield prior to introduction of a working cryogen into the cryogen vessel.

### BACKGROUND AND SUMMARY OF THE INVENTION

FIG. 1 shows a schematic cross-section of a conventional arrangement of a cryostat including a cryogen vessel 12. A cooled superconducting magnet 10 is provided within cryogen vessel 12, itself retained within an outer vacuum chamber (OVC) 14 by suspension arrangements known in the art, but not shown in the drawing. One or more thermal radiation shields 16 are provided in the vacuum space between the cryogen vessel 12 and the outer vacuum chamber 14. In some known arrangements, a refrigerator 17 is mounted in a refrigerator sock 15 located in a turret 18 provided for the purpose, towards the side of the cryostat. Alternatively, a refrigerator 17 may be located within access turret 19, which retains access neck (vent tube) 20 mounted at the top of the cryostat. The refrigerator 17 provides active refrigeration to cool cryogen gas within the cryogen vessel 12, in some arrangements by recondensing it into a liquid. The refrigerator 17 may also serve to cool the thermal radiation shield 16. As illustrated in FIG. 1, the refrigerator 17 may be a two-stage refrigerator. A first cooling stage is thermally linked to the radiation thermal radiation shield 16, and provides cooling to a first temperature, typically in the region of 50-100K. A second cooling stage provides cooling of the cryogen gas to a much lower temperature, typically in the region of 4-10K.

A negative electrical connection 21a is usually provided to the magnet 10 through the body of the cryostat. A positive electrical connection 21 is usually provided by a conductor passing through the vent tube 20.

As is well known in the art, a difficulty arises when first cooling such a cryostat from ambient temperature. One option is to simply add working cryogen to the cryogen vessel until the cryogen vessel and the magnet settle at the temperature of the working cryogen. While this may be acceptable when using an inexpensive, non-polluting, essentially inexhaustible cryogen such as liquid nitrogen, it is not considered acceptable to use this approach for a working cryogen such as helium, which is relatively costly to produce, or to re-liquefy, and is a finite resource.

When cooling cryostats from ambient temperature to helium temperature, it is known to pre-cool the cryostat to a first cryogenic temperature by other means, before finally cooling the cryostat to operating temperature by the addition of liquid helium. One conventional method for pre-cooling the cryogen vessel to a first cryogenic temperature involves first adding an inexpensive sacrificial cryogen, typically liquid nitrogen, into the cryogen vessel. The cryostat is then left for some time for temperatures to settle. This may be known as ‘soaking’. The temperature of the cryogen vessel is then allowed to rise above the boiling point of the sacrificial cryogen, to ensure that it is completely removed from the cryogen vessel, before working cryogen is added.

Although the material of the cryogen vessel itself quickly cools on addition of a cryogen, an issue arises with the cooling of the thermal radiation shield(s) 16. In use, these thermal radiation shields must be cooled, typically to about 50K in the case of a single thermal radiation shield in a helium-cooled system. They must be thermally isolated from both the cryogen vessel 12 and the OVC 14, to reduce the thermal influx from the room-temperature OVC to the cryogen vessel when in operating condition. When pre-cooling the cryostat, the thermal isolation of the thermal radiation shield(s) prevents the shield(s) from cooling rapidly on introduction of cryogen into the cryogen vessel.

Known methods of pre-cooling a thermal radiation shield 16 include: operating the refrigerator 17 to cool the thermal radiation shields, or ‘softening’ the vacuum between the OVC and the cryogen vessel by the operation of an amount of gas, so allowing the thermal radiation shields to be cooled by convection heat transfer to the cryogen vessel. Each of these will now be discussed.

1) Operating the refrigerator 17 to cool the thermal radiation shields. This has the disadvantage that any sacrificial cryogen within the cryogen vessel would need to be removed beforehand, since otherwise the sacrificial cryogen will be liquefied or frozen in the cryogen vessel. In known methods, the cryogen vessel is pre-cooled with nitrogen, allowed to warm up to a temperature in excess of the boiling point of nitrogen to ensure that no liquid nitrogen remains, and then is flushed with gaseous helium and then evacuated to ensure no contamination remains, before turning on the refrigerator. The refrigerator then cools the thermal radiation shield at a rate of about 1K/hr.

2) ‘Softening’ the vacuum between the OVC and the cryogen vessel. This will allow some thermal conductivity by convection, allowing heat to be transferred from the thermal radiation shield to the cryogen vessel, where it is removed by boiling of the sacrificial cryogen. Further cooling of the thermal radiation shield may occur by radiation once the working cryogen has been added into the cryogen vessel. Vacuum softening has been found to cool the thermal radiation shield rapidly to about 150 K when the cryogen vessel is filled with liquid nitrogen. Typically, the thermal radiation shield warms to 200 K during the phase when the cryogen vessel is allowed to warm to 80 K to ensure all liquid nitrogen is removed prior to filling with a liquid helium working cryogen. The refrigerator is then used to cool the thermal radiation shield from 200 K to 50 K. This process takes approximately 6 days, during which time approximately 200 liters of liquid helium are typically lost in boil off, at a current cost of about GB£400 (about US$800).

While the financial cost of the lost helium is significant, the length of time required for cooling is also troublesome. Conventionally, the recondensing operation of the refrigerator is tested before the cryostat was shipped to a customer. This requires cooling of the thermal radiation shield to about 50K, since higher thermal radiation shield temperatures will radiate more heat to the cryogen vessel than the recondensing refrigerator can remove. However, more recently, the time taken to cool the thermal radiation shield has become the dominant factor in the time taken for magnet tests as a whole. This is particularly so in arrangements with a particularly low quench rate, which is otherwise most desirable. The pressure to ship completed cryostats and magnet systems to customers as soon has possible has led to the refrigerator recondensing test being omitted from some testing protocols. This, in turn, can lead to difficulties later. For example, if any of these cryostats or magnet systems exhibit boil-off issues on, or after, installation, rapid problem diagnosis and correction will be hindered as their baseline cryogenic performance is unknown.

The present invention addresses at least some of the drawbacks of the prior art.

### BRIEF DESCRIPTION OF THE DRAWINGS

The above, and further, objects, advantages and characteristics of the present invention will become more apparent from consideration of the following description of certain embodiments thereof, given by way of non-limiting examples only, in conjunction with the accompanying drawings wherein:

FIG. 1 shows a conventional arrangement of a cryostat containing a superconducting magnet;

FIG. 2 shows a schematic drawing of a thermal radiation shield precooling link, according to an embodiment of the present invention, in a first, shield-cooling position;

FIG. 3 shows a schematic drawing of the thermal radiation shield precooling link of FIG. 2, in a second, non-shield-cooling position;

FIG. 4 shows calculated axial and radial forces acting on an example ferrous component, as used in an embodiment of the present invention;

FIG. 5 shows a schematic drawing of a thermal radiation shield precooling link, according to another embodiment of the present invention, in a first, shield-cooling position; and

FIG. 6 shows a schematic drawing of the thermal radiation shield precooling link of FIG. 5, in a second, non-shield-cooling position.

FIG. 7A and 7B are schematic illustrations of an alternative embodiment of the invention.

### DETAILED DESCRIPTION OF THE INVENTION

The present invention provides a decouplable thermal link between the thermal radiation shield and the cryogen vessel. This link is in place during pre-cool, and conducts heat from the thermal radiation shield to the cryogen vessel. After pre-cool, the thermal link is decoupled, removing the thermal path between the cryogen vessel and the thermal radiation shield.

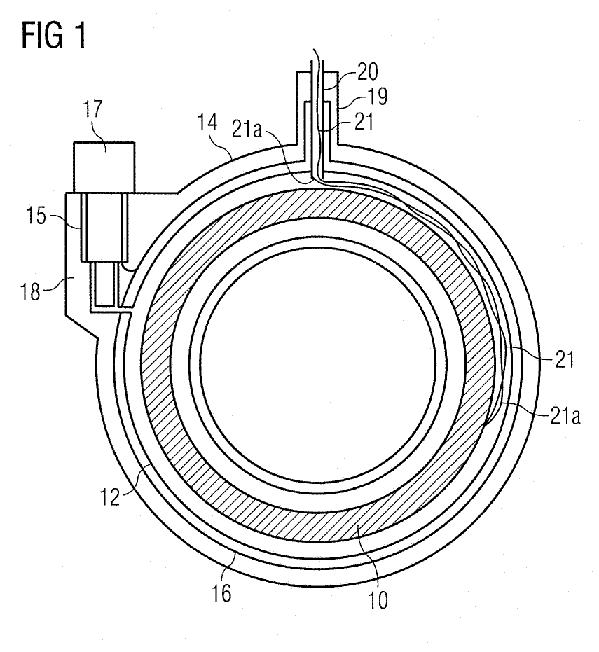

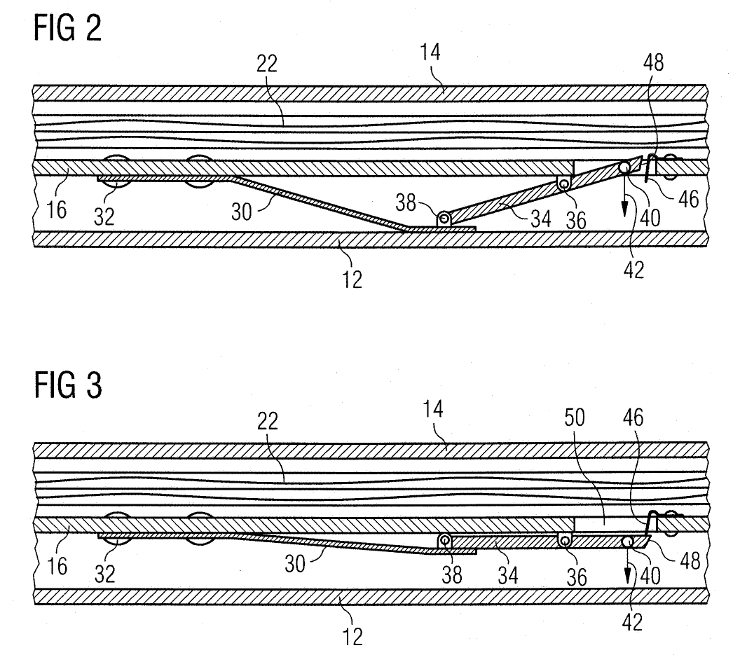

FIG. 2 shows an embodiment of the present invention built into a cryostat housing a superconductive magnet (not shown). The thermal radiation shield precooling link, according to an embodiment of the present invention is shown with its thermally conductive element 30 in a first, shield-cooling position. Only sections of the relevant vessels are shown, and carry labels corresponding to the labels of FIG. 1. Layers of insulating material 22, such as aluminized polyester sheet, also known as “Superinsulation”, may be present between the thermal radiation shield 16 and the OVC 14, but forms no part of the present invention.

In the illustrated embodiment, a sprung, thermally-conductive element 30 extends between the thermal radiation shield 16 and cryogen vessel 12. In the illustrated embodiment, the element 30 is attached to the thermal radiation shield 16 by rivets 32, but could equally be attached by any equivalent means: nuts and bolts, deformed tabs and through-holes, welding, brazing or soldering, and so on. The element 30 is resiliently biased toward the cryogen vessel 12 sufficiently to maintain effective thermal contact. An actuating lever 34, whose function will be discussed below, is mounted on a pivot 36 and is attached to a radially outer surface of the element 30 by a suitable mechanical link, such as a further pivot 38, or a hook, or any equivalent feature. This actuating lever may be thermally conductive, providing a second path for heat transfer from the thermal radiation shield. In this embodiment, in the position shown in FIG. 2, the spring bias of the element 30 holds the actuating lever 34 in the position shown. Thermal conduction is provided from thermal radiation shield 16 to cryogen vessel 12 through the material of the thermally-conductive element 30. During pre-cool, the cryogen vessel 12 is partly filled with a sacrificial cryogen such as liquid nitrogen. The cryogen vessel will be cooled to the temperature of boiling nitrogen, which is about 76K. Heat from the thermal radiation shield 16 will flow through the thermally-conductive element 30 and actuating lever 34 to the cryogen vessel, where it will be removed by boil-off of sacrificial cryogen.

When the pre-cool stage is complete, the cryogen vessel 12 will be cooled to operating temperature, such as about 4K by methods such as those discussed above. In the operating state, it is important to reduce thermal conduction between the thermal radiation shield 16 and the cryogen vessel 12. FIG. 3 shows the thermally conductive element 30 of FIG. 2, in a second, non-shield-cooling position. In this arrangement, the actuating lever 34 retains the thermally-conductive element 30 against its spring bias and away from the cryogen vessel. Further heat may be lost from the thermal radiation shield 16 to the cryogen vessel 12 by radiation, cooling the thermal radiation vessel still further.

Operation of the actuating lever 34 will now be explained, since this effects the transition of the element 30 from the first, shield-cooling position of FIG. 2 to the second, non-shield-cooling position of FIG. 3.

Referring again to FIG. 2, magnetic material such as a ferrous component 40 is attached to, or forms part of, the actuating lever 34, on the opposite side of pivot 36 from the further pivot 38, or equivalent mechanical link to the element 30. With the cooled magnet at operating temperature, cooled by a working cryogen, the magnet is energized. The magnetic field produced by the superconducting magnets exerts an attractive force on the ferrous component 40, in the direction shown at 42. This attractive force acts through pivot 36 to exert a force in the opposite direction on element 30 through the further pivot 38, or equivalent mechanical link. By careful choice of the size of ferrous component 40, actuating lever 34, and the spring strength of element 30, the force acting on ferrous component 40 is sufficient to pull element 30 away from contact with the cryogen vessel. Preferably, a latching arrangement 46 is provided, to retain the actuating lever 34 in the second position, even if the magnetic field produced by the superconducting magnet should reduce or fail altogether. In the illustrated embodiment, the latching arrangement comprises a simple metal leaf spring, riveted or otherwise fastened to the thermal radiation shield 16. As the actuating lever 34 moves form its first position to its second position, an end 48 of the lever deforms the spring 46 and passes by. The spring 46 then returns to its former shape, preventing actuating lever 34 from regaining its first position. FIG. 3 shows the actuating lever 34 retained in position by latch 46 acting upon its end 48.

With the thermally conductive element in its second position, spaced away from the cryogen vessel as shown in FIG. 3, it becomes isothermal with the thermal radiation shield and does not contribute to the thermal load on the cryogen vessel.

In FIG. 3, assuming that the superconducting magnet is active, the ferromagnetic component 40 is being attracted by a force 42 in the direction shown. This causes a force to act on element 30 in the opposite direction, pulling it away from the cryogen vessel into the second position shown in FIG. 3. As shown, a latching mechanism 46, 48 may be provided. If the magnetic field is removed, the lever 34 and the element 30 are retained in this second position, by latch 46 bearing on end 48 of lever 34, which in turn prevents element 30 from returning to the first position (FIG. 2) under its own resilience.

In some embodiments, it may be preferred to omit the latching mechanism 46, 48, such that the element 30 returns to its first position in the absence of sufficient magnetic field to maintain the second position. For example, it may be preferred to provide a thermal link between the thermal radiation shield and the cryogen vessel during shipment of the cryostat, or following a quench. If shipping of a cryostat is unexpectedly delayed, the working cryogen in the cryogen vessel may boil dry, and the cryogen vessel and thermal radiation shield may warm up towards ambient temperature. Similarly, as a result of a quench event, the cryogen vessel may lose all of its working cryogen, and the cryogen vessel and thermal radiation shield may warm up towards ambient temperature. In either situation, a further pre-cool will be necessary, and it would be advantageous for the thermal link of the present invention to be re-established. This would not be possible if the link is latched in its decoupled position. Some known cryostat arrangements are provided with a refrigerator which only cools the thermal radiation shield. Following a magnet quench in such a cryostat, it would be advantageous to re-establish eth thermal link of the present invention between the thermal radiation shield and the cryogen vessel, to enable the refrigerator to assist with cooling of the cryogen vessel.

The thermally conductive element 30 should be of a material of relatively high thermal conductivity, such as copper or aluminum, to provide effective heat transfer from the thermal radiation shield 14 to the cryogen vessel 12. The inventors have calculated that a copper link of cross-sectional area 400 mm2 (e.g. a strip of copper 100 mm wide and 4 mm thick) and of thermal length 100 mm, being the length that the heat is conducted through between the thermal radiation shield 14 and the cryogen vessel 12 placed in good thermal contact between a thermal radiation shield 16 at 300K and a cryogen vessel at 77K would conduct heat at a rate of 368 W. This rate will reduce as the thermal radiation shield cools. When the thermal radiation shield is at 200K, with the cryogen vessel again at 77K, the heat will transfer at a rate of 200 W. Towards the end of the pre-cool process, liquid helium may be introduced into the cryogen vessel as a working cryogen. It will cool the cryogen vessel to 4K. When the thermal radiation shield is at 200K and the cryogen vessel is at 4K, heat will transfer at a rate of 480 W.

As an example, assuming an aluminum thermal radiation shield of mass 180 kg, the change in thermal radiation shield enthalpy between room temperature 300K and thermal radiation shield operating temperature 80K is 2.89×107 J. At an average cooling rate of 200 W, the arrangement of the present invention could cool the thermal radiation shield from 300K to 80K in 40 hours, neglecting heat influx through suspension arrangements. This reduction from 6 days to less than 2 days will shorten the time required for pre-cool, and reduce the temptation to ship magnets without having tested their refrigeration systems to recondensing temperatures.

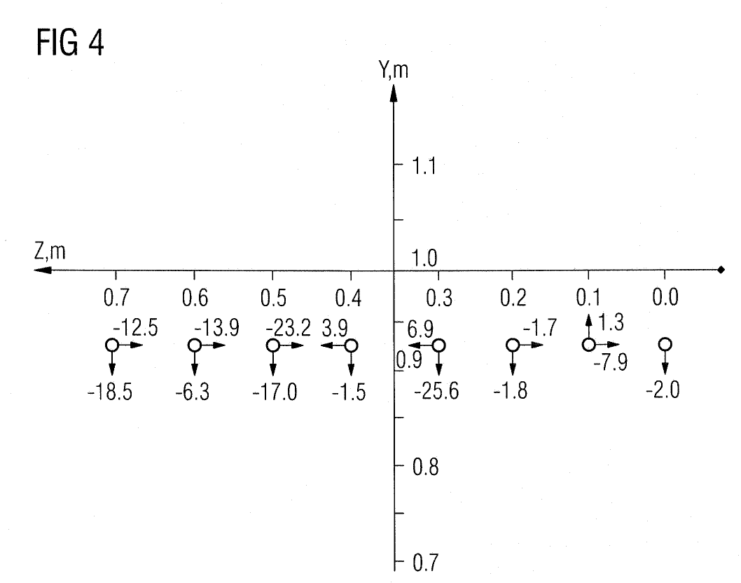

The inventors also performed some modeling to indicate the typical forces which will act upon the ferrous component and so be available to lift the thermally conductive element 30 away from the cryogen vessel 12. A ferrous sphere of mass 33 g and radius 10 mm is assumed, positioned 0.93 m radially from the magnet axis A (FIG. 1), a typical radial position for a thermal radiation shield 16. FIG. 4 schematically illustrates the calculated total force acting on such a ferrous component at a variety of axial positions when an associated superconducting magnet is activated.

As can be seen from FIG. 4, the resultant radial force varies considerably according to the axial position chosen. In the example considered, forces of over 25N are possible even with the relatively small ferrous component considered. Depending on the geometry of the actuating lever 34, the resultant radial force acting to displace the thermally conducting element away from the cryogen may be increased or reduced as compared to the radial force acting on the ferrous component. The available radial force to displace the thermally conducting element 30 away from the cryogen vessel must be balanced with the resilience of the thermally conducting element 30, to ensure that the thermal contact will be effectively decoupled upon activation of the magnet.

A force of 25N would be insufficient to overcome the resilience of a solid copper strip of 400 mm2. Th is problem may be overcome by constructing the thermally conducting element 30 using a laminated section, comprising multiple layers of very thin copper sheet. Alternatively, several thermal links according to the present invention may be provided around the cryostat, to provide the required total cross-sectional area of thermally conductive links. A flexible thermally conducting element 30 may be employed, such as a copper rope or braid. Alternative embodiments also address this issue, as will now be explained.

Although the embodiments described above employ an element 30 which is resilient in itself, other arrangements may be provided. For example, the element 30 may be hinged at the thermal radiation shield 16, and biased into thermal contact with the cryogen vessel 12 by gravity alone. Alternatively, or in addition, a bias spring may be provided to urge the element 30 into contact with the cryogen vessel. Alternatively, or in addition, actuating lever 34 may be resiliently biased so as to urge the element 30 toward the cryogen vessel 12.

In other embodiments, a thinner, resiliently flexible, part of the element 30 is provided near the thermal radiation shield 16, while the main part of the element 30 comprises a thicker material. This compromise would allow effective thermal conduction, with only a relatively short portion of reduced thermal conductivity, in return for reduced axial force required to cause deflection of the conductive element.

The actuation lever 34 and the thermally conductive link 30 are preferably of a non-magnetic material.

In further embodiments, the arrangement of the present invention may be located at a position such that the ferrous component 40 is repelled by the magnetic field when the magnet is active. In such embodiments, the ferrous component 40 should be placed on the same side of pivot 36 as the second pivot 38 or equivalent. In such arrangements, it may not be necessary to provide hole 50 in the thermal radiation shield. In such embodiments, the actuating lever may not extend beyond the pivot 36. Actuating lever 34 and/or thermally conductive element 30 may be of a magnetic material, since the resultant force will repel the actuating lever and thermally conductive element towards the second position shown in FIG. 3.

According to an aspect of the present invention, a thermally conductive link is provided during pre-cool, such that cooling of the cryogen vessel by sacrificial cryogen also serves to pre-cool the thermal radiation shield. On activation of the superconducting magnet, the resultant field causes the thermally conductive link to decouple, ensuring thermal isolation between the cryogen vessel and the thermal radiation shield while the magnet is in use. Optionally, the thermally conductive link may latch in its decoupled position, maintaining thermal isolation between the thermal radiation shield and the cryogen vessel even when the magnetic field ceases.

No specific user or service operation needs to be undertaken to decouple the thermal link, and access to the link of the present invention is generally not required. Should it become necessary to dismantle the cryostat for any reason, the thermally conductive element of the thermal link of the present invention may be unlatched from its second position and returned to its first position in preparation for a further pre-cool operation when the cryostat is rebuilt. In embodiments where no latch is provided, the thermally conductive element of the thermal link of the present invention will revert to its first position automatically as the magnetic field ceases.

While the present invention has been described with particular reference to the pre-cooling of superconducting magnets, the present invention may also be applied to precooling of other cryogenically cooled apparatus, provided that a strong magnetic field is provided after precooling to decouple the thermal link of the present invention between the thermal radiation shield and the cryogen vessel.

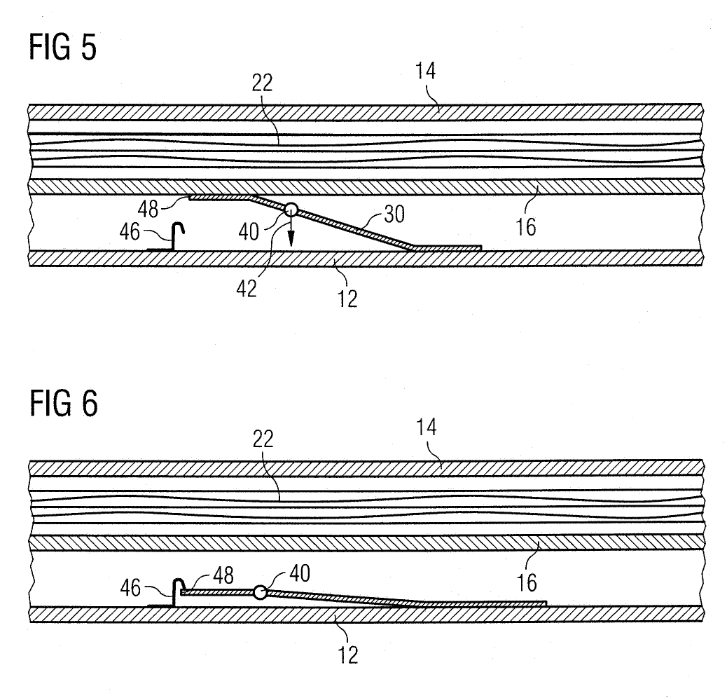

FIGS. 5 and 6 show an alternative embodiment of the present invention, respectively in a first, shield-cooling position; and in a second, non-shield-cooling position, similar to the view in FIGS. 2 and 3.

In FIGS. 5 and 6, the thermally conductive element 30 is fixed to the outside of the cryogen vessel 12 by some non-piercing fixing method, like brazing, welding, soldering or adhesive bonding, using an adhesive with an acceptably high thermal conductivity. The ferrous component 40 is mounted on a thermally conductive element 30 which is biased into contact with thermal radiation shield 16. The thermally conductive element 30 may be so biased by virtue of its own resilience, or a spring (not illustrated) may be provided. Operation of the thermal link arrangement of FIGS. 5 and 6 is much the same as operation of the arrangement illustrated in FIGS. 2 and 3. On activation of a magnetic field, a magnetic attraction force 42 pulls the ferrous component 40 towards the cryogen vessel 12 and brings the thermally conductive element 30 out of contact with the thermal radiation shield 16. Such an arrangement is simpler than that of FIGS. 1 and 2, as the actuating lever is not required.

In some embodiments, the thermal link arrangement of FIGS. 5 and 6 is placed near the top of the cryostat, such that gravity assists the magnetic force 42 acting upon the thermally conductive element, so making it possible to use a thicker thermally conductive element. Alternatively, the thermal link arrangement of FIGS. 5 and 6 may be placed near the bottom of the cryostat, such that gravity assists the biasing of the thermally conductive element 30 into contact with the thermal radiation shield 16, which may be useful with a more flexible thermally conductive element 30, such as a copper braid. Many of the variations discussed with reference to FIGS. 2 and 3 may be applied to the thermal link arrangement of FIGS. 5 and 6. For example, the thermally conductive link 30 may be hinged rather than being flexible; a latching mechanism 46, 48 may be provided as illustrated.

In the thermal link arrangement of FIGS. 5 and 6, the thermally conductive element could comprise a magnetic material. This may be instead of, or in addition to, the presence of the ferrous component 40. Some grades of steel may satisfy the necessary requirements of being magnetic, thermally conductive and resilient. In particular, in certain embodiments, the thermally conductive element 30 may comprise a bi-metallic strip, comprising a metal of high thermal conductivity, for example copper, and a magnetic ferrous metal. Preferably, the dimensions and properties of such a thermally conductive element would be selected such that it has a sufficiently high thermal conductivity, is arranged such that different thermal contraction rates assist in the actuation of the thermal link for precooling by laying flat against the cryogen vessel 12 when at ambient temperature, but bending towards the thermal radiation shield 16 when the cryogen vessel 12 is cooled towards operating temperature; and is sufficiently magnetic that it displaces away from the thermal radiation shield 16 into the second position shown in FIG. 6 on application of a magnetic field.

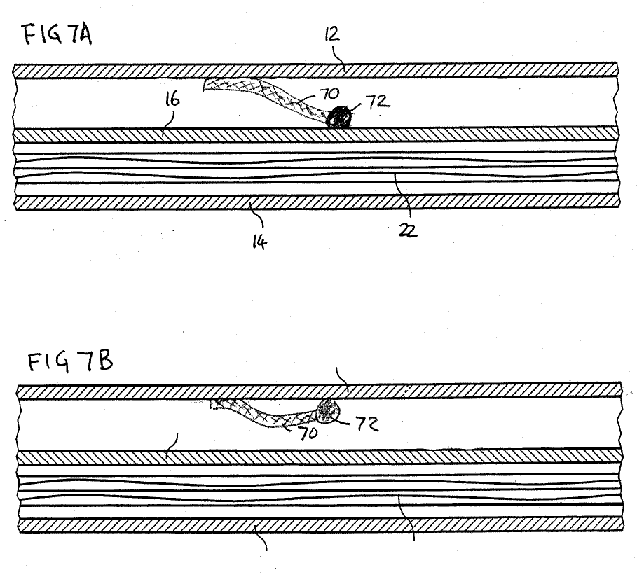

FIGS. 7A-7B show a simple embodiment of the invention, in which a flexible, thermally conductive non-magnetic material 70, for example, copper or aluminum rope, braid or laminate, is provided with ferrous component 72 placed at a free end. Such an arrangement may be attached to the outside of the cryogen vessel 12 by a non-piercing fixing method, for example by soldering, brazing or adhesive bonding with an acceptable thermally conductive adhesive; or may be attached to the thermal radiation shield 16, for example by soldering, brazing or adhesive bonding; or bolting, riveting or resilient deformation of a tab formed in the material of the shield. The arrangement should be positioned so as to provide a thermally conductive path, under gravitational influence, between the cryogen vessel and the thermal radiation shield when the magnet is inactive (shown in FIG. 7A), and to be displaced by a magnetic field to break the thermally conductive path when the magnet is active (shown in FIG. 7B). This may be achieved by placing the arrangement towards the bottom of the cryogen vessel, and attaching it to the cryogen vessel in a position where the magnet, when active, will attract the ferrous component, while, when the magnet is inactive, the arrangement will flex under gravitational influence to contact the thermal radiation shield. FIGS. 7A-7B show such an arrangement. Alternatively, the arrangement may be placed towards the top of the cryogen vessel, attached to the thermal radiation shield in a position where the magnet, when active, will repel the ferrous component, such as the position represented by Z=0.1 m in FIG. 4, while, when the magnet is inactive, the arrangement will flex under gravitational influence to contact the cryogen vessel. In yet further embodiments, the flexible, thermally conductive material may be magnetic. In such embodiments, ferrous component 72 may or may not be provided.

As described above, the thermally conductive element 30 in any of the described embodiments may comprise any one of: a flexible or hinged strip of thermally conductive non-magnetic material such as copper; a flexible or hinged strip of thermally conductive magnetic material such as steel; a thermally conductive laminate such as stacked sheets of copper; a flexible thermal conductor such as copper rope or braid, a bimetallic strip which deforms on cooling. An appropriate choice of material for the thermally conductive element will be made based upon the particular arrangement under consideration.

While the present invention has been described with reference to certain embodiments, by way of non-limiting examples only, numerous variations and modifications will be apparent to those skilled in the art. While the present invention has been particularly described with reference to superconducting magnets for MRI systems, it may be applied to cryogenically cooled magnets for any purpose, such as magnetic resonance spectroscopy or particle acceleration. While the present invention has been described with particular reference to cooling to liquid helium temperatures, it may be applied to cooling by any cryogen, such as nitrogen, hydrogen, neon and so on. While various embodiments of the invention are described as including ferrous materials of ferrous components, these parts need not be of iron or steel, but may be of any material which may be attracted or repelled by an applied static magnetic field.

What is claimed is:

1. A cryostat comprising a cryogen vessel housed within an outer vacuum container (OVC), a thermal radiation shield being located between an external surface of the cryogen vessel and an internal surface of the OVC, wherein
a decouplable thermal link arrangement is provided between a first surface, being an external surface of the cryogen vessel and a second surface, being an internal surface of the thermal radiation shield, and
said decouplable thermal link arrangement is actuable by action of an applied magnetic field.

2. A cryostat according to claim 1, further comprising superconductive magnet coils housed within the cryogen vessel, which may be activated to provide the applied magnetic field.

3. A cryostat according to claim 1, wherein the decouplable thermal link arrangement comprises:
a thermally conductive element connected to a first one of said first surface and said second surface and, in a first position, biased into thermal contact with a second one of said first surface and said second surface; and
a ferrous component mechanically linked to the thermally conductive element, whereby the thermally conductive element may be displaced from the first position into a second position, not in thermal contact with the second one of said first surface and said second surface, by action of an applied magnetic field on the ferrous component.

4. A cryostat according to claim 3, wherein the ferrous component is secured to the thermally conductive element.

5. A cryostat according to claim 1, wherein the decouplable thermal link arrangement comprises:
a thermally conductive element connected to a first one of said first surface and said second surface and, in a first position, biased into thermal contact with a second one of said first surface and said second surface; wherein the thermally conductive element comprises a magnetic material, whereby the thermally conductive element may be displaced from the first position into a second position, not in thermal contact with the second one of said first surface and said second surface, by action of an applied magnetic field on the magnetic material.

6. A cryostat according to claim 5, wherein a latching mechanism is provided, to retain the thermally conductive element in said second position.

7. A cryostat according to claim 3, wherein bias of the thermally conductive element is provided by resilience of the thermally conductive element itself.

8. A cryostat according to claim 3, wherein bias of the thermally conductive element is provided by a spring mechanically linked to the thermally conductive element.

9. A cryostat according to claim 3, wherein bias of the thermally conductive element is provided by gravity acting on the thermally conductive element.

10. A cryostat according to claim 3, wherein an actuating lever is provided, pivoted upon a pivot secured to the first one of said first surface and said second surface, said actuating lever comprising a magnetic material, and said actuating lever is mechanically secured to the thermally conductive element.

11. A cryostat according to claim 10, wherein a latching mechanism is provided, to retain the actuating lever in such position as to retain the thermally conductive element in said second position.

12. A cryostat according to claim 3, wherein the first one of said first surface and said second surface is the external surface of the cryogen vessel; and the second one of said first surface and said second surface is the internal surface of the thermal radiation shield.

13. A cryostat according to claim 3, wherein the thermally conductive element comprises any one of:
a flexible strip of thermally conductive non-magnetic material;
a flexible strip of thermally conductive magnetic material;
a hinged strip of thermally conductive non-magnetic material;
a hinged strip of thermally conductive magnetic material;
a thermally conductive laminate;
a flexible thermal conductor; and
a bimetallic strip which deforms on cooling.

14. A method of pre-cooling a thermal radiation shield in a cryostat comprising a cryogen vessel housed within an outer vacuum container (OVC), a thermal radiation shield being located between an external surface of the cryogen vessel and an internal surface of the OVC, the method comprising providing a thermally conductive link during pre-cool, such that pre-cooling of the cryogen vessel also serves to pre-cool the thermal radiation shield; and, on activation of the superconducting magnet, the resultant magnetic field causes the thermally conductive link to decouple, ensuring thermal isolation between the cryogen vessel and the thermal radiation shield while the magnet is in use.

15. The method of claim 14 further comprising latching the thermally conductive link in its decoupled position, maintaining thermal isolation between the thermal radiation shield and the cryogen vessel.

16. A cryostat according to claim 1, wherein the decouplable thermal link arrangement comprises:
a flexible thermally conductive element connected to a first one of said first surface and said second surface,
in a first position, resting under gravitational influence in thermal contact with a second one of said first surface and said second surface;
wherein the thermally conductive element comprises a magnetic material,
whereby the thermally conductive element may be displaced from the first position into a second position, not in thermal contact with the second one of said first surface and said second surface, by action of an applied magnetic field on the magnetic material.

17. A cryostat according to claim 16, wherein the thermally conductive element carries a ferrous component.

18. A cryostat according to claim 1, wherein the decouplable thermal link arrangement comprises:
a flexible thermally conductive non-magnetic element connected to a first one of said first surface and said second surface,
in a first position, resting under gravitational influence in thermal contact with a second one of said first surface and said second surface;
wherein the thermally conductive element carries a ferrous component,
whereby the thermally conductive element may be displaced from the first position into a second position, not in thermal contact with the second one of said first surface and said second surface, by action of an applied magnetic field on the ferrous component.
